(19) United States
(12) Patent Application Publication
(10) Pub. No.: US 2014/0078894 A1
(43) Pub. Date: Mar. 20, 2014

(54) LANE FAULT RECOVERY APPARATUS AND METHOD

(71) Applicant: Electronics and Telecommunications Research Institute, Daejeon-si (KR)

(72) Inventors: Kyeong-Eun HAN, Daejeon-si (KR); Eun-Young Cho, Daejeon-si (KR); Tae-Hyun Kwon, Gyeongsangbuk-do (KR); Sun-Me Kim, Daejeon-si (KR); Jong-Hyun Lee, Daejeon-si (KR)

(73) Assignee: Electronics and Telecommunications Research Institute, Daejeon-si (KR)

(21) Appl. No.: 13/964,626

(22) Filed: Aug. 12, 2013

(30) Foreign Application Priority Data
Sep. 17, 2012 (KR) 10-2012-0102940

(51) Int. Cl. H04L 12/24

(52) U.S. Cl. CPC H04L 41/0668
USPC 370/228

(57) ABSTRACT

Provided are a multi-lane-based Ethernet lane fault recovery apparatus and method capable of detecting a lane fault separately from a link fault and identifying one or more lanes where the lane fault has occurred. The lane fault recovery apparatus includes a communication unit configured to comprise a plurality of data transmission lanes, distribute data between the plurality of data transmission lanes in response to the receipt of a control command and photoelectrically convert the data; and a connection processing unit configured to detect the occurrence of a fault from the plurality of data transmission lanes, exclude one or more faulty lanes where the fault has occurred from the plurality of data transmission lanes and transmit the data via the rest of the data transmission lanes that are available for use. The connection processing unit may be further configured to transmit data via a switched backup link.

### CROSS-REFERENCE TO RELATED APPLICATION(S)

This application claims the benefit under 35 U.S.C. §119(a) of Korean Patent Application No. 10-2012-0102940 , filed on Sep. 17, 2012, in the Korean Intellectual Property Office, the entire disclosure of which is incorporated herein by reference for all purposes.

### BACKGROUND

1. Field

The following description relates to a multi-lane-based Ethernet apparatus for high-speed transmission, and more particularly, to a lane fault recovery apparatus and method of a multi-lane-based Ethernet apparatus.

2. Description of the Related Art

Under the influence of the fusion of different types of communication environments and digital fusion, rapid growth of multimedia communication services have come to require a high-speed broadband transmission system. Accordingly, there is an increasing need for high-speed Ethernet transmission technology that supports a data rate of tens of gigabits or more.

The high-speed Ethernet transmission technology includes techniques employing a multi-lane structure. The multi-lane structure includes a group of several lanes (for example, 40G/100G lanes) having a lower transmission rate in order to establish a link having a high transmission rate, i.e., a single aggregated high-speed link. For example, an Ethernet transmission system having a high data transmission rate can be built by processing data transmitted from a media access control (MAC) layer to a physical (PHY) layer at a transmission rate of 100 gigabits using ten lanes each having a transmission rate of 10 gigabits for 100 gigabit Ethernet.

With this structure, a high-speed transmission system which can yield valuable effects using a plurality of inexpensive elements can be implemented. However, such broadband transmission of tens of gigabits or more must have high reliability because of mass data transmission.

In the case of a conventional wavelength-division multiplexing (WDM) link, data is transmitted via each wavelength (or channel) separately. On the other hand, in the case of a multi-lane-based link (for example, a 40G/100G Ethernet), which is a high-speed link consisting of a plurality of lower-speed lanes (or wavelengths), a single data stream may be processed and transmitted by being distributed between the plurality of lanes.

Accordingly, in the case of a WDM link, the occurrence of a fault in a single channel does not affect data transmitted via other channels. On the other hand, in the case of a multi-lane-based link, a single faulty line affects all other lanes because data transmitted via each lane in the multi-lane-based link accounts for only a portion of all data to be transmitted. As a result, a lane fault may bring about the same results as a whole link fault. A high-speed network with a multi-lane-based structure is highly susceptible to a fault, and may suffer from a considerable amount of packet loss in response to the occurrence of a fault.

Standardized Ethernet technology uses a local fault (LF) message and a remote fault (RF) message to signal a link fault. The LF and RF messages are intended for recognizing only an Ethernet link fault, indicating the fault, and performing a protection switching function.

Conventional protection switching technology with high reliability includes a control to re-establish a path in a 1+1 and 1:N method or use a previously set backup path for Ethernet link fault recovery at a system or network level.

However, when this technology is applied to the Ethernet structure having a multi-lane, the fault of one lane is processed as a whole link fault, such that protection switching is performed on the entire link traffic. Also, when protection switching is performed in response to the detection of a link fault, packet loss is inevitable during the switching of a backup link, which is more apparent for higher-speed transmission networks.

Accordingly, a technique is needed for quickly performing fault recovery in consideration of the properties of a multi-lane-based Ethernet while minimizing packet loss during the switching of a backup link.

### SUMMARY

The following description relates to a multi-lane-based Ethernet lane fault recovery method and apparatus capable of detecting a lane fault separately from a link fault and detecting faulty lanes.

In one general aspect, a lane fault recovery apparatus includes: a communication unit configured to comprise a plurality of data transmission lanes and in response to the receipt of a control command, distribute data between the plurality of data transmission lanes and photoelectrically convert the data; and a connection processing unit configured to detect the occurrence of a fault from the plurality of data transmission lanes, exclude one or more faulty lanes where the fault has occurred from the plurality of data transmission lanes and transmit the data by adjusting a transmission rate of the plurality of data transmission lanes via the rest of the data transmission lanes that are available for use.

The connection processing unit may be further configured to transmit data via a switched backup link. The connection processing unit may be further configured to use the backup link in response to the number of faulty lanes exceeding a maximum allowable number of faulty lanes. The connection processing unit is further configured to generate a lane fault message including the number and location of faulty lanes and transmit the lane fault message to a receiving party. The lane fault message may use a 66-bit frame including seven 8-bit sub-frames and a 10-bit sub-frame. The connection processing unit may be further configured to transmit data received from a media access control (MAC) layer to the communication unit.

In another aspect, a lane fault recovery method includes: detecting the occurrence of a fault from a plurality of data transmission lanes; identifying faulty lane information including the number and location of faulty lanes where the lane fault has occurred; notifying an upper layer and a receiving party of the occurrence of the lane fault; and transmitting data via the plurality of data transmission lanes except for the faulty lane(s) by adjusting the data transmission rate of the plurality of data transmission lanes.

The lane fault recovery method may also include switching a backup link to a usable state and transmitting the data via the switched backup link. The backup link may be set to be used in response to the number of faulty lanes exceeding a maximum allowable number of faulty lanes.

Other features and aspects may be apparent from the following detailed description, the drawings, and the claims.

### BRIEF DESCRIPTION OF THE DRAWINGS

FIG. 1 is a diagram illustrating an example of a multi-lane-based Ethernet lane fault recovery apparatus.

FIG. 2 is a diagram illustrating an example of a connection processing unit.

FIG. 3 is a diagram illustrating an example of a communication unit.

FIG. 4 is a flowchart illustrating an example of a multi-lane-based Ethernet lane fault recovery method.

FIG. 5 is a flowchart illustrating an example of a multi-lane-based Ethernet lane fault recovery method using backup links.

FIG. 6 is a diagram illustrating an example of a lane fault message.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

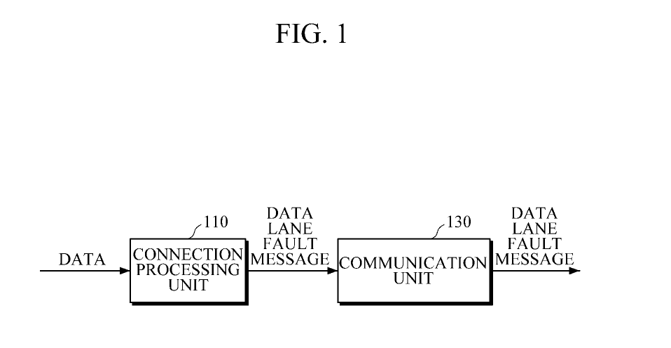

FIG. 1 is a diagram illustrating an example of a multi-lane-based Ethernet lane fault recovery apparatus.

Referring to FIG. 1, a multi-lane-based Ethernet lane fault recovery apparatus includes a connection processing unit 110 and a communication unit 130.

The connection processing unit 110, which is an interface for connecting a media access control (MAC) layer and a physical (PHY) layer, transmits data received from the MAC layer to the communication unit 130.

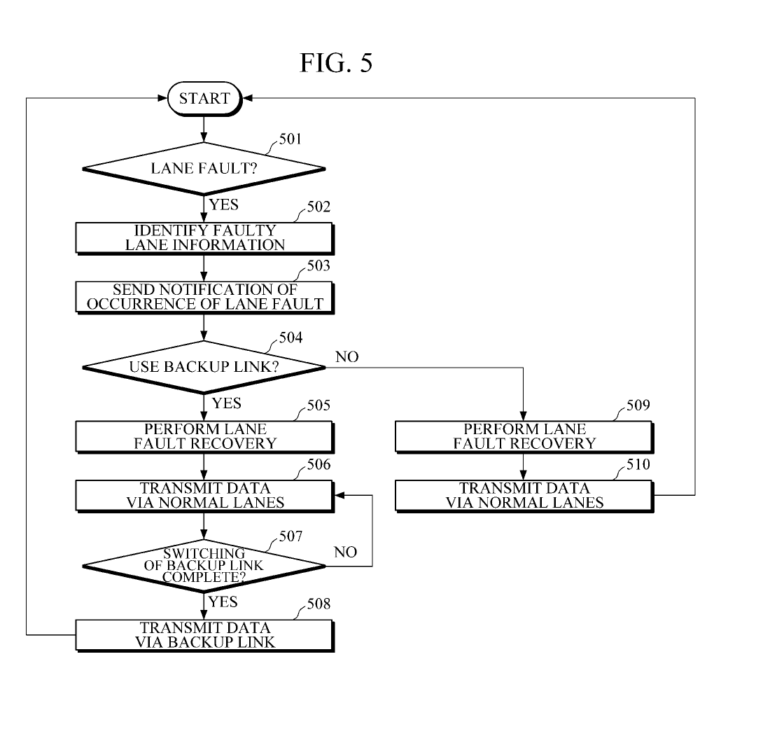

In response to the occurrence of a lane fault in a multi-lane-based Ethernet, the connection processing unit 110 detects the lane fault and identifies faulty lane information including the number and location of faulty lanes where the lane fault has occurred. Then, the connection processing unit notifies an upper layer of the occurrence of the lane fault, generates a lane fault message and transmits the lane fault message to the connection processing unit of a receiving party (not illustrated). The lane fault message may include the number and location of faulty lanes where the lane fault has occurred. An example of the lane fault message will be described in further detail with reference to FIG. 5.

In response to the occurrence of a lane fault, the connection processing unit 110 excludes a faulty lane where the lane fault has occurred so that data can no longer be transmitted via the faulty lane. The connection processing unit 110 may perform a lane fault recovery process by adjusting the number of normal lanes. In response to the lane fault recovery process being complete, the connection processing unit 110 adjusts the data transmission rate in accordance with the number of normal lanes available for use and transmits data via normal lines.

In response to the occurrence of a lane fault, the connection processing unit 110 may transmit data via backup links. In response to the occurrence of a lane fault, the connection processing unit 110 transmits data first via available lanes excluding a faulty lane where the lane fault has occurred, i.e., via normal lanes. The connection processing unit 110 may transmit data only via the normal lanes. Alternatively, in response to a particular condition for using a backup link being met, the connection processing unit 110 may transmit data only via the normal lanes and may then switch over to a backup link and transmit data via the backup link.

A backup link may or may not always be used whenever a lane fault occurs. In an example, a backup link may be configured to be always used whenever a lane fault occurs. In this example, data may be transmitted only via normal lanes during the switching of the backup link, and then, in response to the switching of the backup link being complete, data may be transmitted via the backup link.

In another example, a backup link may be configured to be used only when a predetermined condition is met, for example, when the number of faulty lanes exceeds a maximum allowable number of faulty lanes. More specifically, in response to the occurrence of a first lane fault, data is transmitted via available lanes excluding a first faulty lane where the first lane fault has occurred. Then, in response to the occurrence of a second lane fault, data is transmitted via the available lanes excluding both the first faulty lane and a second faulty lane where the second lane fault has occurred. In response to the number of faulty lanes exceeding the maximum allowable number of faulty lanes, a backup link may be used. In this example, data may be transmitted only via normal lanes during the switching of the backup link, and then, in response to the switching of the backup link being complete, data may be transmitted via the backup link.

It takes time to switch a backup link to a usable state for transmitting data. Accordingly, during the switching of a backup link, data loss occurs, and the amount of data lost increases in accordance with the speed of the network. To minimize such data loss, data may be transmitted via normal lanes until the switching of a backup link is complete, and may then be transmitted via the backup link in response to the switching of the backup link being complete.

In a case in which there is no backup link available in a network, a considerable amount of data loss may occur during the switching of a backup link. However, since the multi-lane-based Ethernet lane fault recovery apparatus illustrated in FIG. 1 transmits data via normal lines first in response to the occurrence of a link fault, it is possible to minimize data loss even when there is no available backup link.

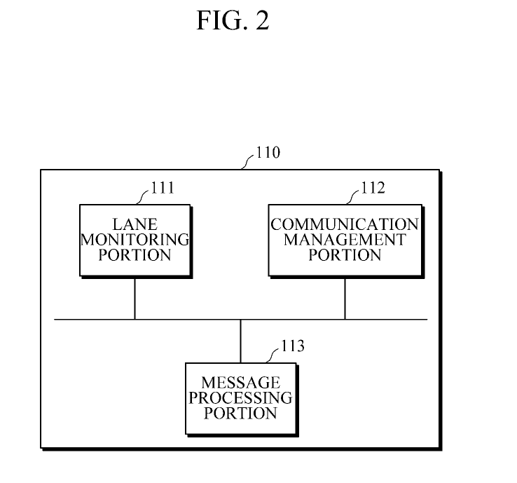

The communication unit 130 distributes data received from the connection processing unit 110 between a plurality of lanes, photoelectrically converts the received data and transmits the photoelectrically converted data to the connection processing unit of a receiving party. The communication unit 130 will be described later in further detail with reference to FIG. 2.

FIG. 2 is a diagram illustrating an example of the connection processing unit 110.

Referring to FIG. 2, the connection processing unit 110 includes a lane monitoring portion 111, a communication management portion 112 and a message processing portion 113.

The lane monitoring portion 111 monitors lanes for communication. If a lane fault occurs, the lane monitoring portion 111 detects the lane fault, identifies the number and location of faulty lanes where the lane fault has occurred, generates faulty lane information including the results of the identification, and transmits the faulty lane information to the communication management portion 112 and the message processing unit 113.

The communication management portion 112 controls lanes based on the faulty lane information received from the lane monitoring portion 111.

More specifically, in response to the receipt of the faulty lane information from the lane monitoring portion 111, the communication management portion 112 excludes a faulty lane where the lane fault has occurred from all available lanes so that data can no longer be transmitted via the faulty lane. The communication management portion 112 may adjust the number of normal lanes and may perform a lane fault recovery operation. In response to the lane fault recovery operation being complete, the communication management portion 112 adjusts the data transmission rate in accordance with the number of normal lanes available for use, and thus transmits data via normal lanes.

The communication management portion 112 may also transmit data by means of an additional backup link after the transmission of data via all the available lanes except for the faulty lane, i.e., via normal lanes.

It takes time to switch a backup link to a usable state for transmitting data. During the switching of a backup link, data loss may occur, and the amount of data lost may increase in accordance with the speed of a network. To minimize such data loss, data may be transmitted via normal lanes until the switching of a backup link is complete, and may then be transmitted via the backup link in response to the switching of the backup link being complete.

In response to the receipt of the faulty lane information from the lane monitoring portion 111, the message processing portion 113 notifies an upper layer of the occurrence of the lane fault, generates a lane fault message and transmits the lane fault message to the connection processing unit of a receiving party. The lane fault message may include the number and location of faulty lanes where the lane fault has occurred.

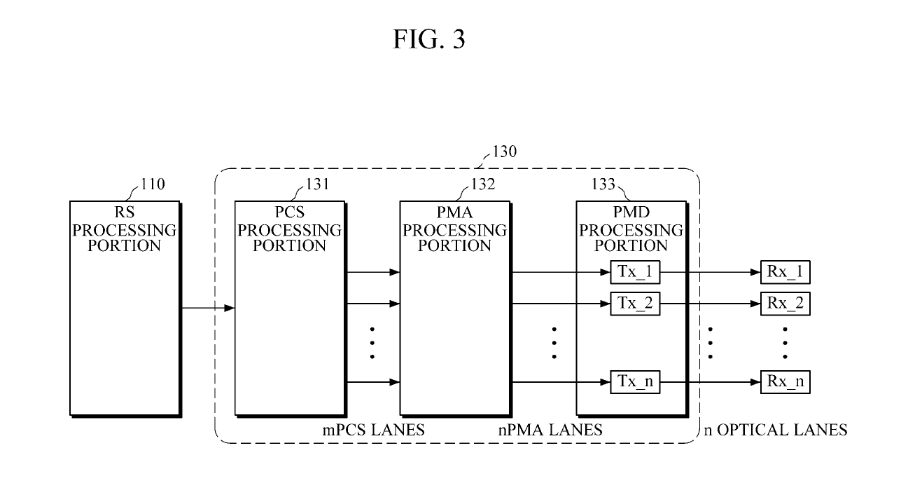

FIG. 3 is a diagram illustrating an example of the communication unit 130.

Referring to FIG. 3, the communication unit 130 includes a physical coding sublayer (PCS) processing portion 131, a physical medium attachment (PMA) processing portion 132 and a physical medium dependent (PMD) processing portion 133.

The PCS processing portion 120 includes m PCS lanes. The PCS processing portion 120 outputs data provided by the connection processing unit 110 to the PMA processing portion 130 by distributing the data between a plurality of PCS lanes, wherein the plurality of PCS lanes are virtually distributed lanes.

The PMA processing portion 130 includes n PMA lanes. The PMA processing portion 130 receives m PCS lanes from the PCS processing portion 120, and outputs n PMA lanes. The n PMA lanes are electrical lanes, whereas PMA lanes are virtual lanes. The number of PCS lanes provided by the PCS processing portion 120, i.e., m, may be greater than or the same as the number of PMA lanes output by the PMA processing portion 130. More specifically, in the case of, for example, a 40 G Ethernet, m=n=4, whereas in the case of a 100 G Ethernet, m=20 and n=10 or 4.

The PMD processing portion 140 photoelectrically converts data and a control block received from the PMA processing portion 130 via the n PMA lanes, and transmits the photoelectrically converted data and control block to a receiving party via an optical link including n optical lanes. The link used to transmit the photoelectrically converted data and control block to the receiving party is not limited to an optical link. That is, various other transmission media may be used to transmit the photoelectrically converted data and control block to the receiving party.

There may be a fixed correspondence between PCS lanes, PMA lanes and optical lanes. For example, data distributed into an x-th PCS lane may always be transmitted via a y-th optical lane.

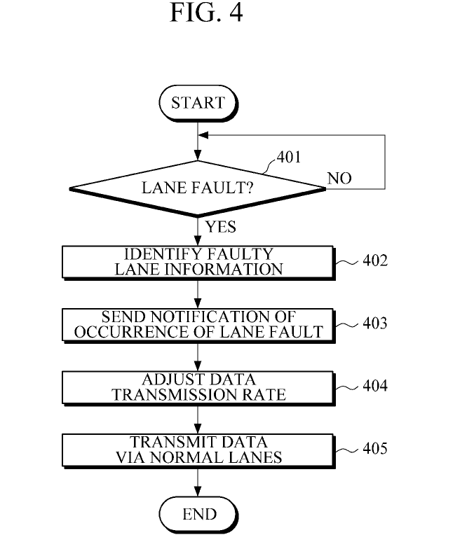

FIG. 4 is a flowchart illustrating an example of a multi-lane-based Ethernet lane fault recovery method.

Referring to FIG. 4, a determination is made in 401 as to whether a lane fault has occurred. In an example, in response to the occurrence of a lane fault in a lane of a multi-lane-based Ethernet, the lane fault may be detected by means of a fault occurrence sensing signal. In this example, in response to the receipt of no fault occurrence sensing signal, the multi-lane-based Ethernet may continue to be monitored.

Thereafter, information on one or more faulty lanes in which the lane fault has occurred are identified in 402. More specifically, in response to a determination being made, based on the receipt of a fault occurrence sensing signal, that the lane fault has occurred, information on the faulty lanes may be identified. The information on the faulty lanes, i.e., faulty lane information, may include the number and location of faulty lanes.

Thereafter, a notification of the occurrence of the lane fault is sent in 403. More specifically, after the identification of the faulty lane information, a notification of the occurrence of the lane fault is sent to an upper layer, a lane fault message including the faulty lane information is generated, and the lane fault message is transmitted to a receiving party. In an example, one or more lane fault messages corresponding to the number of faulty lanes may be generated and may then be transmitted one after another to the receiving party.

Thereafter, the data transmission rate is adjusted in 404. More specifically, in response to the receipt of a lane fault response message from the receiving party, the faulty lane(s) may be excluded from all available lanes so that data can no longer be transmitted via the faulty lane(s). Then, the data transmission rate may be adjusted in accordance with the number of normal lanes available for use so that data can be transmitted only via normal lanes. Thereafter, data is transmitted via the normal lanes in 405.

According to the embodiment illustrated in FIG. 4, it is possible to transmit data only via normal lanes by excluding one or more faulty lanes and adjusting the data transmission rate appropriately. Therefore, it is possible to recover faulty lanes while minimizing data loss.

FIG. 5 is a flowchart illustrating an example of a multi-lane-based Ethernet lane fault recovery method using a backup link.

Referring to FIG. 5, a determination is made in 501 as to whether a lane fault has occurred. In an example, a determination made as to whether a lane fault has occurred by determining whether a fault occurrence sensing signal has been received. In this example, in response to the receipt of no fault occurrence sensing signal, a multi-lane-based Ethernet may continue to be monitored.

Thereafter, information on one or more faulty lanes in which the lane fault has occurred are identified in 502. More specifically, in response to a determination being made based on the receipt of a fault occurrence sensing signal that the lane fault has occurred, information on the faulty may be identified. Information on the faulty lanes, i.e., faulty lane information, may include the number and location of faulty lanes.

Thereafter, a notification of the occurrence of the lane fault is sent in 503. More specifically, after the identification of the faulty lane information, a notification of the occurrence of the lane fault is sent to an upper layer, a lane fault message including the faulty lane information is generated, and the lane fault message is transmitted to a receiving party. In an example, one or more lane fault messages corresponding to the number of faulty lanes may be generated and may then be transmitted one after another to the receiving party.

Thereafter, a determination is made in 504 as to whether to use a backup link. Data intended to be transmitted via the faulty lane(s) may be switched to and transmitted via a backup link available in a network. In response to a determination being made that a backup link is not to be used, lane fault recovery is performed in 509 by using the same method as illustrated in FIG. 4, and data is transmitted via normal lanes in 510. A backup link may be used in accordance with a predefined condition. In an example, a backup link may be set to be used whenever a faulty lane is discovered or only when the number of faulty lanes exceeds a maximum allowable number of faulty lanes. In this example, in response to the number of faulty lanes not exceeding the maximum allowable number of faulty lanes, lane fault recovery may be performed, and then data may be transmitted only via normal lanes.

Thereafter, lane fault recovery is performed in 505. More specifically, the faulty lane(s) may be excluded from all available lanes, and the data transmission rate may be adjusted in accordance with the number of normal lanes available for use so that data can be transmitted only via normal lanes. Thereafter, data is transmitted via the normal lanes in 506.

A determination is made in 507 as to whether the switching of the backup link has been complete. Since it takes a predetermined amount of time to switch the backup link to a usable state, a determination may need to be made, before the transmission of data to the backup link, as to whether the backup link has been properly switched and is thus ready. If data is transmitted to the backup link before the completion of the switching of the backup link, data may continue to be lost until the switching of the backup link is complete. In response to a determination being made that the switching of the backup link has been complete, data is transmitted via the backup link in 508.

According to the embodiment illustrated in FIG. 5, it is possible to recover more than one faulty lane by excluding the faulty lanes, transmitting data only via normal lanes and then transmitting data via a backup link through the switching of the backup link. Also, since data is transmitted via normal lanes until the switching of a backup link is complete, it is possible to minimize data loss that may occur during the switching of the backup link. Also, even when there is a backup link shortage, it is possible to continue to transmit data by means of normal lanes.

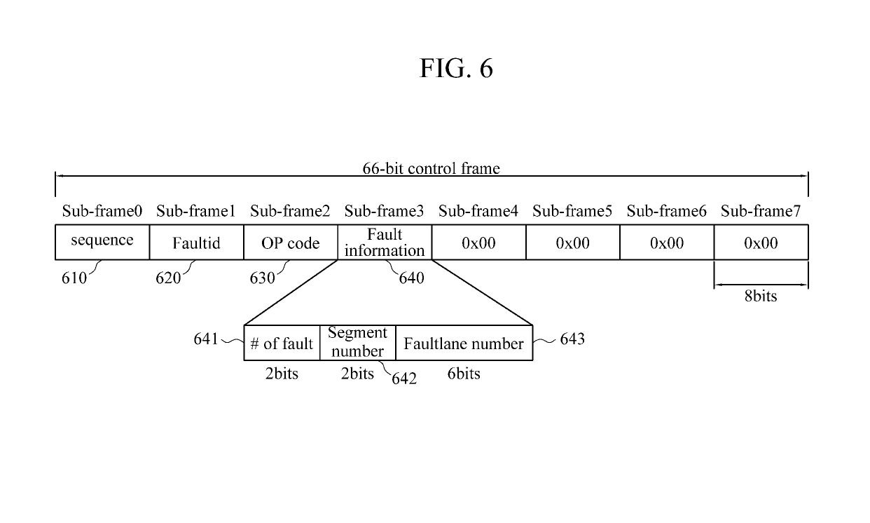

FIG. 6 is a diagram illustrating an example of a lane fault message.

Referring to FIG. 6, a lane fault message is generated, processed and transmitted by a connection processing unit. A 66-bit control frame may be used as the lane fault message, and a particular field of the 66-bit control frame may be used to deliver the type of the lane fault message and lane fault information. The lane fault message may include 8 sub-frames, which are each 8 bits long. In an example, the lane fault message may be configured based on a sequence-ordered set frame. Sub-frame 0 in 610 includes a sequence value. For example, in the case of a 40 G/100 G Ethernet, sub-frame 0 in 610 may include a sequence value of 0×9 C. Sub-frame 1 in 620 includes fault information indicating whether the corresponding fault is a link fault or a lane fault, i.e., a fault identifier (ID). For example, a fault ID of 0×00 may indicate a link fault, and a fault ID of 0×01 may indicate a lane fault.

Sub-frame 2 in 630 includes OP code for differentiating a local fault from a remote fault. When the fault ID in 620 is 0×00, an OP code in 630 of 0×01 may indicate a local link fault, and an OP code in 630 of 0×02 may indicate a remote link fault. On the other hand, when the fault ID in 620 is 0×01, the OP code in 630 of 0×01 may indicate a local lane fault, the OP code in 630 of 0×02 may indicate a remote lane fault, and an OP code in 630 of 0×03 may indicate an acknowledgement (ACK) message, which is a message used to notify a receiving party that lane information has been reset and adjusted in accordance with a change in the number of lanes in a PHY layer after the transmission of a remote lane fault message. Sub-frame 3 in 640, which is a fault information field, may include the number of faulty lanes in 641, segment number information in 642 and faulty lane ID information in 643. The lane fault message illustrated in FIG. 6 is exemplary. That is, the lane fault message illustrated in FIG. 6 may be implemented in various manners other than that set forth herein, and the location and bit quantity of each field thereof may vary.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A lane fault recovery apparatus, comprising:
a communication unit configured to comprise a plurality of data transmission lanes and in response to the receipt of a control command, distribute data between the plurality of data transmission lanes and photoelectrically convert the data; and
a connection processing unit configured to detect the occurrence of a fault from the plurality of data transmission lanes, exclude one or more faulty lanes where the fault has occurred from the plurality of data transmission lanes and transmit the data by adjusting a data transmission rate of the plurality of data transmission lanes via the rest of the data transmission lanes that are available for use.

2. The lane fault recovery apparatus of claim 1, wherein the connection processing unit is further configured to transmit data via a switched backup link.

3. The lane fault recovery apparatus of claim 2, wherein the connection processing unit is further configured to use the backup link in response to the number of faulty lanes exceeding a maximum allowable number of faulty lanes.

4. The lane fault recovery apparatus of claim 2, wherein the connection processing unit is further configured to generate a lane fault message including the number and location of faulty lanes and transmit the lane fault message to a receiving party.

5. The lane fault recovery apparatus of claim 4, wherein the lane fault message uses a 66-bit frame including seven 8-bit sub-frames and a 10-bit sub-frame.

6. The lane fault recovery apparatus of claim 1, wherein the connection processing unit is further configured to transmit data received from a media access control (MAC) layer to the communication unit.

7. The lane fault recovery apparatus of claim 1, wherein the connection processing unit is further configured to detect the occurrence of the lane fault by determining whether a fault occurrence sensing signal has been received.

8. A lane fault recovery method, comprising:
detecting the occurrence of a fault from a plurality of data transmission lanes;
identifying faulty lane information including the number and location of faulty lanes where the lane fault has occurred;
notifying an upper layer and a receiving party of the occurrence of the lane fault; and
transmitting data via the plurality of data transmission lanes except for the faulty lane(s) by adjusting a data transmission rate of the plurality of data transmission lanes.

9. The lane fault recovery method of claim 8, further comprising:
switching a backup link to a usable state; and
transmitting the data via the switched backup link.

10. The lane fault recovery method of claim 9, further comprising setting a backup link to be used in response to the number of faulty lanes exceeding a maximum allowable number of faulty lanes.

11. The lane fault recovery method of claim 8, wherein the notifying comprises generating a lane fault message including the faulty lane information; and
transmitting the lane fault message to the receiving party.

12. The lane fault recovery method of claim 11, wherein the lane fault message uses a 66-bit frame including eight 8-bit sub-frames.
